(19) United States
(12) Patent Application Publication
(10) Pub. No.: US 2025/0231105 A1
(43) Pub. Date: Jul. 17, 2025

(54) LASER BASED GAS DETECTOR

(71) Applicant: Wi-Charge Ltd., Rehovot (IL)

(72) Inventors: Ortal Alpert, Ness Ziona (IL); Lior Golan, Ramat Gan (IL); Omer Nahmias, Aminadav (IL); Hen Markovitch, Modiin (IL); Ori Mor, Tel Aviv (IL)

(73) Assignee: Wi-Charge Ltd., Rehovot (IL)

(21) Appl. No.: 18/852,873

(22) PCT Filed: Mar. 31, 2023
(86) PCT No.: PCT/IL2023/050347

§ 371 Date: Sep. 30, 2024

(30) Foreign Application Priority Data
Mar. 31, 2022 (IL) 291878

(51) Int. Cl. G01N 21/39; G01J 3/02; G01N 21/17; G08B 21/18

(52) U.S. Cl. CPC G01N 21/39; G01J 3/027; G08B 21/182; G01N 2021/1793

(57) ABSTRACT

A system for measuring levels of inflammable gases such as cooking gas, in a closed space, and for providing a warning when the gas levels exceed a safe threshold. The system uses a laser beam in order to determine the presence of the intruding inflammable gas. Laser beams provide a convenient method of determining the absorption of gases in the path of the beam, since the beam is generally collimated, traversing a well-defined path, which can cover a large extent of an area to be monitored for gas contamination. The absorption of the light of the laser beam in traversing the area is dependent on the gaseous content of the environment through which the beam passes. The wavelength of the laser beam used is chosen such that there is significant absorption of the beam by the gases which the system is intended to detect in the laser beam.

### FIELD

The present disclosure describes technology related to the field of the detection of impurity gases using a laser beam, especially for detecting inflammable gases in household environments where gas appliances are used for cooking or heating.

### BACKGROUND

Many different types of gas detection sensors exist, include photoionization detectors, ultrasonic sensors, electrochemical sensors, and metal oxide semiconductor (MOS) sensors. A common method of detecting gasses involves the use of a spectrophotometer to analyze gas mixtures, typically using a wideband near-infrared source, such as a tungsten, mercury or incandescent lamp. Such wideband sources provide the ability to perform the measurements over a wide range of wavelengths, where the absorption spectra may then be able to cover different gases. One such spectrophotometric measurement system is shown in the article by J. J. Rohwedder et al, entitled “A miniaturized near-infrared gas sensor based on substrate-integrated hollow waveguides coupled to a micro-NIR-spectrophotometer”, published in The Analyst, 139.10.1039/c4an00556b (2014).

Most of such sensors are mounted in a specific location, typically the center of the ceiling of the space to be protected, and provide a warning of a gas leakage in the near vicinity of the sensor. However, with the increasing use of wireless laser power transmission, such as is used in systems for charging mobile electronic devices, there has arisen a need to provide specific indication of the presence of an intrusion of inflammable gas such as could come from a leakage of gas in the domestic environment, in the path of a laser beam itself, which may have a power density sufficiently high to cause ignition of a combustible gas released by a leakage. For this reason, it is important to determine the concentration of the gas in the path of the laser beam, and over the whole length of the path of the laser beam, since that concentration of gas may be different from the gas concentration at a different location in the same room, such as at a detector mounted in the ceiling of the room. The ceiling mounting position is used to prevent obstructions of air or gas flow by furniture and other objects, whereas cooking gas accumulates in the lower parts of the room, and is especially dangerous at bed height, when gas heaters may be used overnight. Even more importantly, the gas concentration within the beam is particularly susceptible as a safety problem, since the beam is a potential ignition threat localized in a well-defined location, namely the beam path. This danger is made even more acute since installations of wireless laser power charging systems, which are becoming more common nowadays, typically start from the ceiling, while cooking gas, being heavier than air and generally originating at table level or lower, will typically accumulate near the floor. Therefore, it is important to be able to measure and detect gas contamination close to their origin, which could be distant from a ceiling mounted detector.

The disclosures of each of the publications mentioned in this section and in other sections of the specification, are hereby incorporated by reference, each in its entirety.

### SUMMARY

The present disclosure attempts to provide novel systems and methods that overcome at least some of the disadvantages of prior art systems and methods. The present disclosure describes new exemplary systems for measuring levels of impurity gases, and especially inflammable gases such as cooking gas, in a closed space, and for providing a warning or even executing safety actions when the gas levels exceed a predetermined threshold, regarded as a safe level. The systems and methods of the present disclosure differ from previously used gas detection systems in that they use a laser beam in order to determine the presence of the intruding gas. Laser beams provide a convenient method of determining the absorption of gases in the path of the beam, since the beam is generally collimated, traversing a well-defined path, which can cover a large extent of an area to be monitored for gas contamination. The absorption of the light of the laser beam in traversing the area is dependent on the gaseous content of the environment through which the beam passes. So long as there is no gas contamination in the path of the beam, the level of power transferred by the beam does not change significantly since the composition of the air through which the beam passes, remains fairly constant, humidity probably being the main factor in changing the beam absorption. The presently described gas detector system is thus more advantageous than gas monitors which are fitted at a single location, for instance on a ceiling location, since the sensitivity of the detection mechanism of the laser based system does not significantly decrease over the complete path of the laser beam. Such a laser beam can extend from one end of a large room or hall to the other end, thus providing essentially undiminished sensitivity over the whole of the distance. Furthermore, the beam may be scanned over different orientations in the room, thereby covering a larger area of the room.

Laser systems are becoming more widely used to transfer energy remotely from a transmitter to a receiver, where the energy is used for powering mobile personal electronic devices or charging their batteries, or for powering electronic devices installed in locations where the replacement or charging of batteries or the connection to the mains power supply may be problematic, such as in bathrooms or in movable room fittings such as in doors or window shutters and the like. Such remote laser wireless power transmission systems have been described in, for example, a number of patents and patent applications having some common inventors and commonly owned by the present applicant, such as WO 2017/009854, for “A System for Optical Wireless Power Supply”, WO 2017/033192 for “Wireless Power Distribution System”, WO 2018/158605 for “System for Optical Wireless Power Supply”, WO 2017/179051 for “System for Optical Wireless Power Supply”, and WO 2018/211506 for “Flexible Management System for Optical Wireless Power Supply.” Many such systems are used in the domestic environment, including in kitchens or households where gas is used for cooking or for heating. In such cases, the presence of leaking gas in the laser beam court generate a serious safety hazard, since the power density of the laser beam may be capable of igniting the gas leaked into the environment, and causing an explosion. In addition, laser beams may be used as critical components of safety systems, smoke detectors, alarm systems, and medical equipment, and should therefore be kept powered on only so long as it is safe to do so. In any of the above situations, when inflammable gas levels exceed a certain safety threshold, the laser beam should be turned off and a warning alert issued to the user, and/or the fire department and/or gas supply company.

Since a common requirement for such gas detection systems is for detection of dangerous concentrations of cooking gas, this application will be used hereinbelow to describe the systems and methods of the present disclosure, though it is to be understood that this is not intended to be limitation of the present invention and is used mainly to illustrate its uses The systems and methods utilize a laser beam passing from the transmitter to the beam detector located within the room or space whose gas concentration needs to be monitored. According to one aspect of the presently described gas detection systems, the laser beam used to determine the concentration of intruding gas in the environment may be the same laser beam as is used to convey wireless laser charging power to a receiver, since the system's detection of, for instance, flammable cooking gas, is then performed exactly in the path of the laser beam which may be the cause of the ignition of the cooking gas, if such gas leakage is present. However, the presently described systems also provide general detection of the relevant gas in the beam path, whether or not the laser beam would be related to the gas ignition.

The gas detection system of the present application thus comprises a laser transmitter and a receiver, where the transmitter directs a laser beam towards the receiver which converts the energy in the beam into an electrical signal, whose level is dependent on the absorption of the laser beam in the intervening space between the transmitter and the receiver. The wavelength of the laser beam used in the system must be chosen such that there is significant absorption of the beam by the gases which the system is intended to detect in the laser beam. Prior art gas detectors generally use broadband light sources, which therefore can detect different gasses by their absorption at the different wavelengths covered by the broadband source light. Upon detection of the presence above a predetermined threshold of any of the gases whose absorption wavelengths fall within the broadband range of wavelengths of the source, such detectors may be set up to provide a warning signal, or to turn off any system which may potentially be instrumental in igniting the gas, or even to turn off the gas supply. However, since they do not use directed beams, but detect gases reaching the detector from the entire volume surrounding the detector, such prior art volume gas detectors are less capable of detecting dangerous gas levels within a laser beam path itself.

Although a laser beam can be directed along a narrow path in which it is desired to detect dangerous gas concentrations, laser light is narrowband by nature, and thus provides much less data to enable gas detection than a broadband source provides. As a result, when using a laser beam, a smart system is required in order to detect gas. Wavelength selection of the absorption detection light is critical, and in many cases, may differ from the wavelength used for power transfer by a laser beam, as many laser power transmission wavelengths are either not sufficiently absorbed by cooking gas, and hence cannot be used to detect the gas, or are absorbed by other compounds in the air, such as nitrogen, oxygen, water vapor, carbon dioxide, and others, and therefore are insensitive to small percentages of cooking gas. Consequently, the system must work at wavelengths at which high absorption exists for the main cooking gas components, butane and propane. Such wavelength ranges are found between 850-950 nm, 1120-1220 nm, and 1280-1440 nm. The transmitter may therefore advantageously consist of one or more lasers emitting one or more laser beams in wavelength ranges such as the 850-950 nm, 1120-1220 nm, or 1280-1440 nm ranges mentioned above. For a beam range of several meters, as is usual in domestic surroundings, an absorption of between 5% and 10% occurs within these ranges and enables higher sensitivity and hence simpler and more accurate gas detection. In order to cover any of these wavelength ranges, a system with more than one laser may be used, such that a broader band of wavelengths may be covered by the system. In the case of multiple beams of multiple wavelengths the laser beams are advantageously aligned collinearly. In cases where multiple lasers are used, typically at least one laser is modulated to allow differentiation between the measured powers of the different lasers. Such modulation may also be useful in the case of a single laser, allowing better noise reduction using processes such as phase and frequency locking or other pattern sensitive approaches, optical code division multiple access (CDMA) being the extreme case.

The system should also comprise a beam deflection unit used to aim the laser beam towards the receiver and a controller controlling both the laser(s) and the beam deflection system and also ensuring safe operation in the event of a warning of high gas concentration. The receiver may detect the laser beam(s) typically using a photovoltaic cell of a type suitable for the laser wavelength or wavelengths of the laser or lasers. The receiver should also include a digital communication channel for conveying information regarding the received radiation to the transmitter. The communication channel may also be used to transfer information from the transmitter to the receiver. In addition, the information regarding the received radiation at the receiver may be input to the transmitter unit controller in order to determine when the laser beam is impinging optimally on the beam detector in the receiver. The controller can adjust the aiming direction of the beam deflection unit, to ensure this optimal impingement of the beam.

When the detection system is implemented on a laser wireless power transmission system for providing electrical energy to a remote device, whether mobile or static, the receiver would include a DC/DC converter for providing the power to be used by the device receiving the wireless laser power transmission. In order to increase conversion efficiency, a maximum power point tracking system (MPPT) may be included.

Both the transmitter and the receiver should include a power measurement device, for determining the power of the transmitted beam and of the received beam. The transmitted power could be simply represented by measurement of the exciting current into the laser, all the received power could be represented by the output current from the photovoltaic cell. The system can then compute the power absorbed in the passage between the transmitter and the receiver, by the difference between the power(s) received by the receiver and the power(s) transmitted by the transmitter. This may give an overestimation of the absorption of the laser by the gases in the beam between the transmitter and the receiver, as other factors such as beam scattering, beam expansion, reflections from the exit window of the transmitter, or the entry window of the receiver, and other power dispersing effects may also contribute to the reduction of power between the transmitter and the receiver. By computing the power absorbed or scattered along the laser path between the transmitter and the receiver, it is possible to measure the gaseous absorption between the transmitter and the receiver. The system controller typically receives both the transmitter and the receiver power measurements and may calculate the differences, using at least one preliminary calibration measurement to obtain the actual power measured. The power measurement result from the receiver is typically transmitted to the transmitter, where the controller is usually located, by a wireless or partially wireless communication channel, the latter being an arrangement in which the data may be sent using a regular wireless communication protocol to an intermediate wireless access station, from which the data may be accessed by the transmitter over the Internet, for instance.

The controller can then use the data relating to the transmitted power loss, and the known absorption coefficients of the gases expected to be found in the volume, in order to determine the concentration of the gas being detected over the entire length of the laser transmission path from transmitter to receiver. In order to convert the power loss into gas concentration, it is usually necessary to determine the length of the path over which the laser beam is transmitted. Although the detected gas may be somewhat more concentrated in a particular part of the length of the beam path, since it is assumed that air motion in the volume being surveilled results in reasonably uniform volume concentration of gases over the whole of the volume, this effect may be of secondary importance, though the advantage of particularly localized gas concentrations within parts of the laser beam are not inconsiderable. Consequently, an estimate of the distance between the transmitter and receiver can be used to determine the average gas concentration over the entire path. The controller may receive a distance measurement of the receiver by knowledge of the layout of the room and the position of the receiver, or it may be able to estimate the distance by measuring a different property such as the intensity of a test signal transmitted to or reflected from the receiver, or by the size or shape of an optical pattern on the receiver, or by a time of flight measurement of the signal from the transmitter to the receiver and back. As an alternative to involving a path length measurement, the controller may assume a maximal distance based on the system design and parameters.

The controller, being typically also connected to the lasers source(s), may be able to modulate the laser with a specific pattern or modulation, making detection of the signal easier and more sensitive, and may also be able to turn the entire system off when the measurement is not necessary.

The absorption measured is proportional to the absorption of the gaseous medium along the beam length. Some wavelength bands are more sensitive to cooking gas presence, while others may be sensitive to water vapor content. Similarly, some bands may be sensitive to carbon dioxide in the air, while most bands may be used to detect smoke. When the controller detects an absorption rate above a threshold, which is usually predetermined, but may also be calculated on the fly as a result of other parameters detected, it may respond by performing any of the following actions:
1. Turning the laser off or significantly reducing its power
2. Alerting the user
3. Alerting other automatic systems of the situation, such as an alarm system, or a smart hub
4. Initiating a call to the fire department.
5. Sounding an alarm
6. Turn on an illuminated warning, such as an LED light
7. Disconnecting the gas supply, by use of a command to an electronically controlled supply valve.

Typically, the laser may be turned off by a command to the laser driver, but it may also be turned off by switching an optical or mechanical shutter off, to block the beam, or by switching a semiconductor switch in the laser power supply to its non-conducting state.

Once the laser is terminated, or switched to a low power mode, the controller may initiate a recovery protocol after a predetermined time interval, or after cancelation of the warning, either by the user or the fire department, or a remote server, or by a second measurement of the absorption between the transmitter and the receiver, indicating that the risk condition has ceased.

There is thus provided in accordance with an exemplary implementation of the devices described in this disclosure, a system for safe laser power transmission to at least one remote receiver, the system comprising;
a transmitter unit, comprising:
   (a) at least one laser emitter generating a laser beam;
   (b) a beam aiming element adapted to direct the beam towards the at least one receiver; and
   (c) a laser power meter, positioned so that it determines the power of the laser beam;
wherein at least one of the receivers comprises a beam sensor, adapted to receive the laser beam, a power meter configured to measure the level of power input to the receiver by the impinging laser beam, and a communication link, configured to send back to the transmitter, a signal corresponding to the level of power input to the receiver by the impinging laser beam, and
wherein the system further comprises a control unit adapted to determine whether the difference between the power of the laser beam transmitted and the power input to the receiver exceeds a predetermined level, and
wherein the wavelength of the at least one laser emitter is selected such that the laser beam has an absorption by an inflammable gas sufficiently high that the system can detect a predetermined minimal concentration of the gas in the air through which the beam travels, such that the system enables detection of the inflammable gas along the entire path of the laser beam in the region where a remote receiver may be found.

In such a system, the laser beam should advantageously have an absorption by water vapor that does not exceed a predetermined fraction of the absorption by the inflammable gas.

In either of the above systems, the control system should be adapted to utilize the signal corresponding to the level of power input to the receiver to adjust the beam aiming element to ensure optimum impingement of the laser beam on the beam sensor.

In any of the above described systems, the control system may further be adapted to reduce the power emitted by the laser if the difference between the power of the laser beam transmitted and the power input to the receiver exceeds the predetermined level. In that case, if the difference between the power of the laser beam transmitted and the power input to the receiver exceeds the predetermined level, the control system is adapted to perform at least one of the following actions:
a. Turning the laser off, or reducing its power to a predetermined safe level,
b. Alerting the user,
c. Alerting automatic warning systems, such as an alarm system, or a smart hub,
d. Initiating a call to the fire department,
e. Sounding an alarm,
f. Turning on a visual warning signal, and
g. Disconnecting the gas supply, by use of a command to a controlled supply valve.

Additionally, in any of the previously described systems, the beam sensor may be a photovoltaic cell.

Furthermore, any of those systems may further comprise DC/DC converter circuitry, adapted to convert the output current of the beam sensor to a current at a higher voltage, such that the current is at a voltage suitable for powering an externally connected electronic device. Alternatively, such a system may then further comprise DC/DC converter circuitry, adapted to convert the output current of the beam sensor to a current at a higher voltage, such that the current is at a voltage suitable for charging the battery of an externally connected electronic device. In either of those cases, the system may further comprise a maximum power point tracking system, to ensure optimum efficiency of the DC/DC converter circuitry.

In any of the above described systems, the control unit may be situated in the transmitter unit. Furthermore, the difference between the power of the laser beam transmitted and the power input to the receiver is a fractional difference.

Additionally, the wavelength of the at least one laser emitter may fall in at least one of the bands having wavelength ranges of 820-935 nm., 970-1125 nm., 1170-1350 nm., 1515-1545 nm, and 1620-1700 nm.

Finally, there is further provided according to another implementation of the present application, a method of safe laser power transmission to at least one remote receiver, in a space where at least one gas powered appliance may be used, the method comprising:
(i) measuring the power of a laser beam transmitted from a transmitter through the space towards a receiver,
(ii) measuring the power of the laser beam received by the receiver, after traversing the space; and
(iii) determining the difference between the power of the laser beam emitted from the transmitter into the space, and the power input to the receiver after traversing the space, and if the difference exceeds a predetermined level, turning the laser off, or reducing its power to a predetermined safe level,
wherein the wavelength of the laser beam is selected such that the beam has an absorption by a gas used in the appliance sufficiently high that a predetermined minimal concentration of the gas in the space through which the beam travels to the receiver, is sufficient to cause the predetermined level of power difference to be reached, such that the method enables detection of a dangerous level of the appliance gas along the entire path of the laser beam in the space where a remote receiver may be found.

### BRIEF DESCRIPTION OF THE DRAWINGS

The present invention will be understood and appreciated more fully from the following detailed description, taken in conjunction with the drawings in which:

FIG. 1 shows schematically an exemplary system as described in the present disclosure, for providing safe laser wireless power transmission in an environment where there exists the possibility of inflammable gas contamination;

FIG. 2 is a flow chart describing how a system such as that shown in FIG. 1 operates in use;

FIG. 3 is a graph showing the absorption level of a sample of humid air as a function of wavelength, over the visible and the near infrared regions; and

FIG. 4 is a graph showing the spectral absorbance of four different flammable gases—methane, ethane, propane and butane—as a function of wavelength over the near-infrared region.

### DETAILED DESCRIPTION

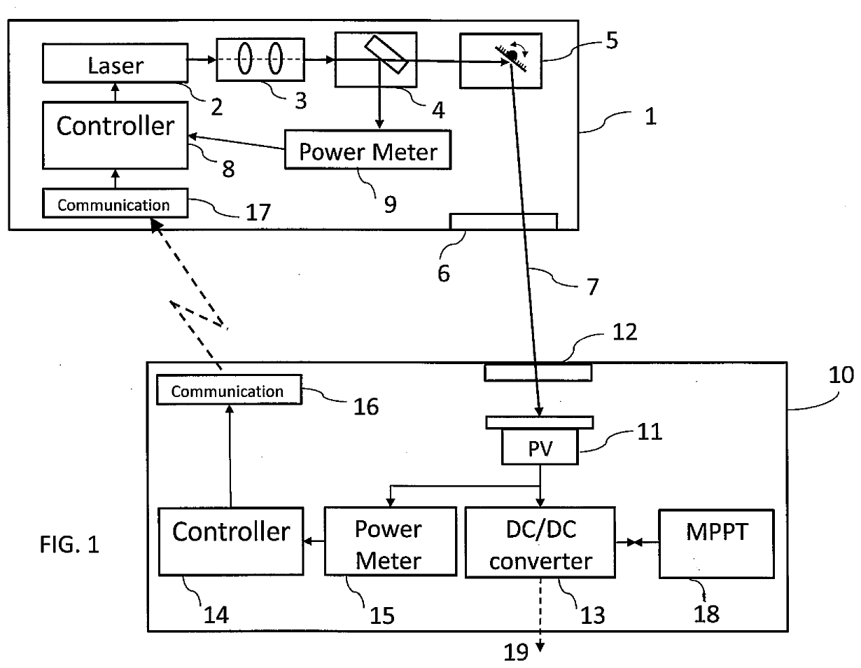

Reference is now made to FIG. 1, which illustrates schematically an exemplary system for detecting the presence of inflammable gas contamination in an environment such as in the domestic setting, where gas is used for cooking and/or heating. A gas leakage could generate a combustible atmosphere in the environment, which could be ignited to generate an explosion by a spark or any other ignition process to which the flammable gas is exposed. This would be particularly so if the gas detector system is incorporated into a laser wireless power transmission system, where the concentrated power density of the collimated laser beam is substantially higher than would be used in a laser system solely for gas detection. Such a system differs from prior art gas detection systems, in that it detects the presence of the inflammable gas specifically along a region where the inflammable gas may be ignited, namely, exactly along the path of the laser beam. The system thus provides a self-protecting safety feature to enable transmission of laser power beams in an environment where there may be danger of an explosive atmosphere.

In FIG. 1 there is shown a transmitter 1 for generating and transmitting a laser power beam 7 into the space where there a receiver 10 is situated, the receiver intended to receive the power beam 7 and to convert it into electrical power, optionally for use by an external device 19 to be powered or charged. In FIG. 1, the path of the optical beams is shown as thicker black lines than the power of electrical or electronic signals, which are shown as thinner lines The transmitter 1, comprises a laser beam generator 2 outputting a beam having a wavelength or range of wavelengths of between 820-935 nm, or 970-1125 nm, or 1170-1350 nm, or 1515-1545 or 1620-1700 nm., or any combination of those ranges. The reason for the selection of the wavelengths of the preferred ranges will be further expounded hereinbelow. An optical system 3 collimates the beam, or focuses it, to a distance of at least 1 m. from the transmitter 1. An output coupler 4 splits off a portion of the beam, typically of up to about 15%, to enable the power output of the beam to be measured by means of a power meter 9. The beam then passes to a beam deflection element 5, such as a controlled aiming mirror, or a MEMS actuated mirror, which directs the beam 7 through the output window 6, towards the receiver 10 situated remotely from the transmitter. A controller 8 in the transmitter may be used to control the direction of the beam deflection element 5, and of the power level and any modulation applied to the output beam of the laser emitter 2.

The power beam 7 impinges on the receiver 10 and is absorbed by a beam sensor, usually in the form of a photovoltaic cell 11 protected behind the receiver entry window 12. The photovoltaic cell 11 absorbs most of laser beam 7 and a DC/DC converter 13 is used to convert the output current of the photovoltaic cell 11 into a current having a higher and more suitable voltage for use in charging or operating a client device 19, if the detection system is also used for providing wireless power to such a device (not shown in FIG. 1). An optional maximum power point tracking system 18 (MPPT) may be used to ensure that the photovoltaic cell output sees the optimum impedance to maximize the power extracted from the photovoltaic cell 7. A power meter 15 is used to estimate the power level of the received laser beam 7, either through measuring the optical power of the beam directly, or, more conveniently since they are purely electronic methods, as shown in the embodiment of FIG. 1, by measuring the current generated by the photovoltaic cell 7, or the voltage generated by the photovoltaic cell 7, or the power generated by the MPPT 18, or by using some other property which is related to the optical power level received. The power meter 15 reports the power level received to receiver controller 14, which sends the power data, or a result of a calculation based on the measurement of the power data, wirelessly through a communication channel transmitter 16, back to the transmitter, where it is received by the receiver 17 of the communication channel, and input to the controller 8. Though most conveniently situated within the transmitter 1 itself, the system controller 8 can be situated either in the transmitter 1, or in any other suitable location, remotely from the transmitter.

When the system controller 8 detects that the power detected at the receiver 10 is lower by more than a predetermined level from the power transmitted from the transmitter, as measured by power meter 9, this may indicate a gas leakage, since the replacement of the air in the laser beam path by the combustible gas causes an increased absorption of the laser beam. This is particularly so if the power detected at the receiver is declining over time while the power output from the transmitter is not. Such a situation seems to indicate a slowly increasing level of contaminant gas in the laser beam path. If such a case is detected, and there is no indication that the received power drop is due to an alternative known reason, then the system controller may determine that a gas leakage is present, and, depending on the level of the contamination, may either terminate the beam emitted from the transmitter by turning off the laser 2, or it may reduce the power level emitted by the laser 2 to a safe level until the source of the power absorption is verified its. The system is thus specifically designed to detect the presence of combustible gas in the laser path itself, where it may be ignited by the power density of the collimated or focused laser beam. In addition, in some implementations of these systems, once such detection of a potential combustible gas leak is established, it may be important for the system to shut down completely to prevent any risk of a spark from an electronic circuit from igniting the gas. Prior to shutting down, or after, or concurrently with the laser power reduction, the system may electronically alert any of a security system, a main server, an alarm system or a fire prevention or detection systems. The system may be configured to also signal to persons in the vicinity about the danger, by activating a warning light, or sounding a warning sound, or by calling the gas company and/or the local fire department.

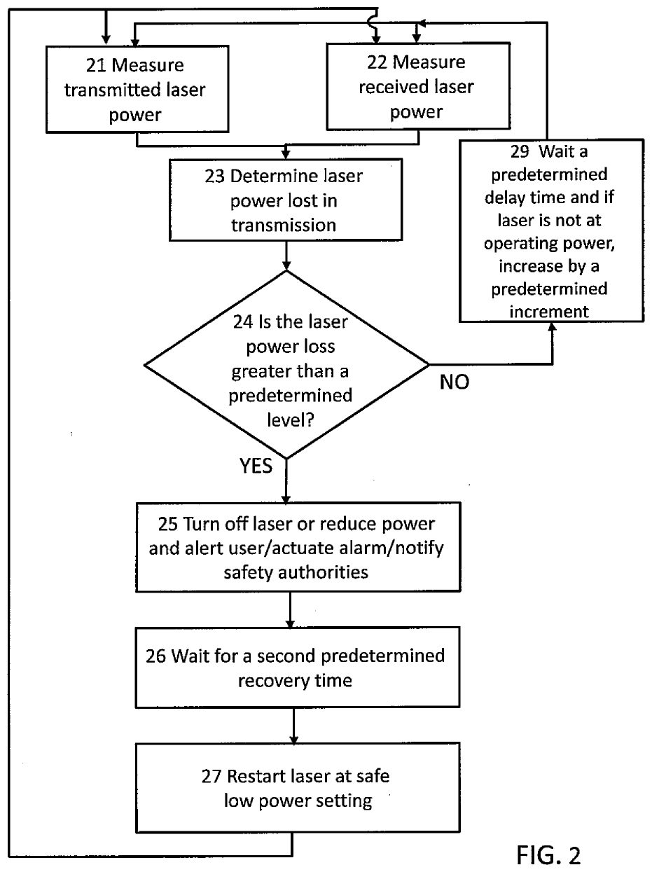

Reference is now made to FIG. 2, which is a flow chart showing an exemplary operational procedure implemented in a system such as that shown in FIG. 1, while it is transmitting laser power to a remote receiver.

In step 21, the current level of the transmitted laser power is measured for entry into the control system.

Simultaneously, in step 22 the level of the laser power received in the receiver is also measured for entry into the control system.

In step 23, the difference in power between the transmitted beam and the received beam is calculated, this representing the power loss during the transmission process. That power loss is more usefully determined as a percentage of the transmitted power, in order to take account of different operating conditions, since the power loss expected under normal operating conditions, without any hint of an unsafe situation, will be dependent on such factors as the distance the receiver is located from the transmitter, any level of contamination on the optical surfaces of the receiver or transmitter, and the like.

In step 24 the controller determines whether the loss of power between the transmitter and the receiver exceeds a predetermined level. That predetermined level should have been determined in a preliminary calibration of the system, to ascertain the expected reduction in power due to replacement of the air in the transmitted laser beam path, with various percentages of the specific gas or gas mixture whose presence is being detected. taking into account the absorption by that particular gas or gas mixture, of the wavelength of the laser used, or of the wavelengths of the lasers used. In step 24, if it is determined that the power loss does not exceed the predetermined safety level, then the system returns to steps 21 and 22, and continues continuously monitoring the power of the transmitted and received laser beam. A short delay can be introduced in step 29 before returning to steps 21 and 22, if continuous monitoring is not regarded as essential.

If, however, in step 24 it is determined that the power loss does exceed the predetermined safety level, this signifies that there may be a leakage of the inflammable gas into the space through which the laser beam is passing, and in step 25, the controller is instructed to either reduce the laser power to a lower standby configuration, or more preferably, to turn off the laser completely. That decision could be dependent on the extent by which the detected power loss exceeds the predetermined safety level. At the same time, the system sends an alert or an alarm to the user or to the overall electronic safety system, and also optionally sends an alert to the fire department or the gas utility company.

Step 29 is also implemented when the system is in its initial low power starting mode, such as during initial start-up, or after having been shut down because of a safety hazard detection, as is explained in step 27 below. Step 29 then uses this delay step for the safe start-up procedure of the system. The system should always start up in a safe, low power mode, not only to ensure that there is no person or other object in the beam path, but in the context of this application, to ensure that there is no dangerous level of gas already present before the laser is turned on. In such a situation, the system start up is terminated while the laser beam is still at a low power setting, thereby avoiding any danger which could occur if the laser were turned on initially at full power.

In step 26, after the laser has been turned off because of a hazard warning by the system, the controller waits for a predetermined recovery time, which is selected according to the specific conditions of the location, in order to determine whether the atmosphere has recovered from the gas contamination, or whether the contamination still exists or has even increased.

In step 27, once the predetermined recovery time is reached, the laser system is restarted, at a lower power setting, as explained hereinabove, to prevent the laser beam power from possibly igniting the combustible gases if they are still present, and control is passed back to steps 21 and 22, where the transmitted and received power levels are again measured. At this reduced power setting, the safety threshold of the difference in power transmitted and received is, of course, reduced according to the reduction in transmitted power in the low power mode. Determination of the lost power in step 23 as a percentage of the transmitted power enables this step to be simply carried out at the reduced power setting. If the system detects in step 24 that the explosion danger has now passed, the laser power can then be raised to its desired level via step 29.

The wavelength or wavelengths at which the laser beam is generated, have to be carefully selected in order to ensure that the absorption of the gas to be detected is sufficiently significant to be able to accurately determine the percentage of contaminant gas in the laser beam, as outlined hereinabove in the Summary section of this disclosure.

The systems described hereinabove utilize laser generators which have laser wavelengths adapted to provide sufficient absorption to detect the gas or gases of interest. In a residential setting, it is the often desired to detect cooking gas, which is generally made up of propane or butane or a mixture thereof. The systems can also operate as smoke detectors, in which case the laser wavelengths are significantly less critical, since smoke is largely particular, with the particles scattering the laser radiation rather than absorbing it. Cooking gas is absorbed efficiently by the following wavelength ranges, in which there is a high level of absorption for butane and/or propane gases: 850-950 nm, 1120-1220 nm, and 1280-1440 nm. However, some laser wavelengths within those ranges are also strongly absorbed by humidity in the air, and this generates an uncertainty as to the power loss due to absorption by the butane and/or propane gas, as compared with the absorption of the water vapor in the ambient air. Consequently, the gas detection systems of the present disclosure should not make use of those spectral regions having a high water vapor absorption level.

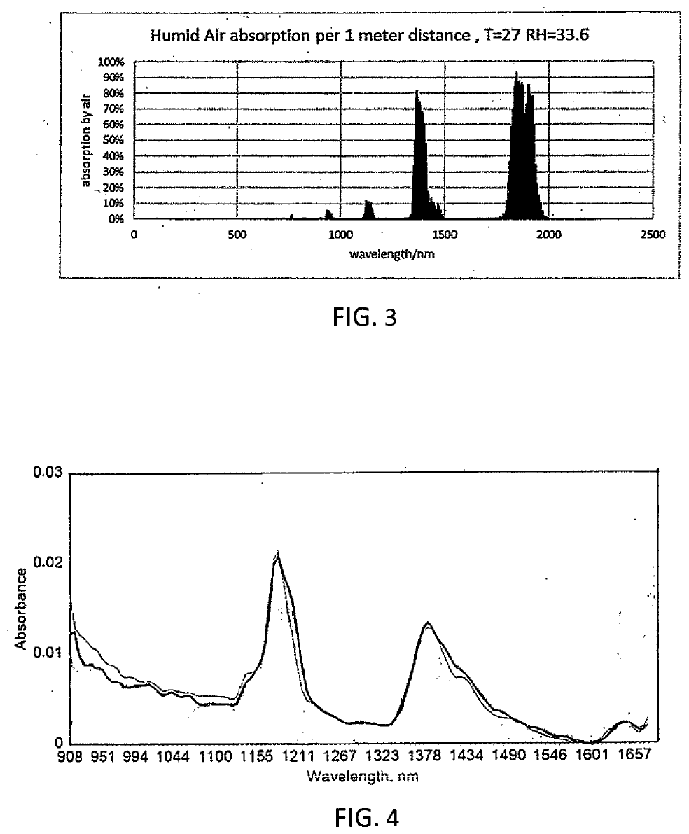

Reference is now made to FIG. 3, which is a graph showing the absorption level of humid air as a function of wavelength, over the visible and the near infrared regions. The absorption data was obtained for an air sample at 27° C. having a relative humidity of 33.6%, over a distance of 1 m. As is observed in FIG. 3, there are water absorption regions over a considerable range of wavelengths in the near infra-red, and these wavelengths should not therefore be used in the systems of the present application. Specifically, preferred wavelengths are those between the water vapor absorption bands, such as between 700-935 nm and 970-1125 nm, as well as the bands between 1170-1350 nm and 1515-1700 nm. Within these ranges, the laser beam is not absorbed strongly by air humidity. Since low water vapor absorption and good propane or butane absorption do not exactly overlap, some compromise is used in order to select suitable wavelengths to provide good detection efficiency. Propane and butane, absorb strongly in the 820-935 nm and 970-1125 nm ranges, which are therefore preferred, in addition to bands between 1170-1350 nm and 1515-1545 nm and 1620-1700 nm., since the laser beam is not absorbed strongly by air humidity in those ranges, but is reasonably absorbed by the cooking gas in the event of a gas leak, enabling detection with good risk reduction.

Reference is now made to FIG. 4, which is a graph showing the spectral absorbance of two flammable gases—propane and butane—as a function of wavelength over the near-infrared region. These gases are generally used as cooking gas for domestic consumption. The lighter trace is for propane, and the darker trace, for butane. The most effective laser wavelengths to use are those which fall (i) in the high absorbance spectral regions shown in FIG. 4, such that there is a sufficient change in the laser beam absorption to changes in the concentration of the gas being detected, and (ii) not in the high water absorption regions of FIG. 3, so that beam absorption from the ambient humidity does not appreciably interfere with the detection of the gas being detected. It is to be understood that in order to detect other inflammatory or dangerous gasses, such as some of those in FIG. 5, other laser wavelengths should be used.

Finally, there is now provided some explanation of the characteristics of inflammable gases, and the dependence of the possibility of an explosive mixture as a function of the concentration of those gases in the air.

Reference is now made to the Appendix Table below, which summarizes a list of common inflammable gases and their danger levels of explosion as a function of their concentration in the air. When the concentration of the gas in air is above what is known as the lower explosive limit (LEL) expressed in volume percentage in the Appendix table below, and below the upper explosive limit (UEL), under normal oxygen conditions, if there is a spark, or some material heated by a laser beam to a high temperature, there is a significant likelihood that a dangerous explosion may occur. In a typical residential or commercial environment, the main danger of this sort arises from a cooking gas leak, cooking gas being mainly comprised of propane or butane or a mixture thereof. For common gasses, it can be seen from the Appendix that volume concentrations of above 1% may pose a danger of such an explosion.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. Furthermore, it is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

APPENDIX

| Gas | LEL | UEL |
|---|---|---|
| Acetone | 2.6 | 13 |
| Acetylene | 2.5 | 100 |
| Acrylonitrile | 3 | 17 |
| Allene | 1.5 | 11.5 |
| Ammonia | 15 | 28 |
| Benzene | 1.3 | 7.9 |
| 1,3 Butadiene | 2 | 12 |
| Butane | 1.8 | 8.4 |
| n Butanol | 1.7 | 12 |
| 1 Butene | 1.6 | 10 |
| Cis 2 Butene | 1.7 | 9.7 |
| Trans 2 Butene | 1.7 | 9.7 |
| Butyl Acetate | 1.4 | 8 |
| Carbon Monoxide | 12.5 | 74 |
| Carbonyl Sulfide | 12 | 29 |
| Chlorotrifluoro ethylene | 8.4 | 38.7 |
| Cumene | 0.9 | 6.5 |
| Cyanogen | 6.6 | 32 |
| Cyclohexane | 1.3 | 7.8 |
| Cyclopropane | 2.4 | 10.4 |
| Deuterium | 4.9 | 75 |
| Diborane | 0.8 | 88 |
| Dichlorosilane | 4.1 | 98.8 |
| Diethylbenzene | 0.8 | |
| 1.1 Difluoro 1 Chloroethane | 9 | 14.8 |
| 1.1 Difluoroethane | 5.1 | 17.1 |
| 1.1 Difluoro ethylene | 5.5 | 21.3 |
| Dimethylamine | 2.8 | 14.4 |
| Dimethyl Ether | 3.4 | 27 |
| 2,2 Dimethyl propane | 1.4 | 7.5 |
| Ethane | 3 | 12.4 |
| Ethanol | 3.3 | 19 |
| Ethyl Acetate | 2.2 | 11 |
| Ethyl Benzene | 1 | 6.7 |
| Ethyl Chloride | 3.8 | 15.4 |
| Ethylene | 2.7 | 36 |
| Ethylene Oxide | 3.6 | 100 |
| Gasoline | 1.2 | 7.1 |
| Heptane | 1.1 | 6.7 |
| Hexane | 1.2 | 7.4 |
| Hydrogen | 4 | 75 |
| Hydrogen Cyanide | 5.6 | 40 |
| Hydrogen Sulfide | 4 | 44 |
| Isobutane | 1.8 | 8.4 |
| Isobutylene | 1.8 | 9.6 |
| Isopropanol | 2.2 | |
| Methane | 5 | 17 |
| Methanol | 6.7 | 36 |
| Methylac etylene | 1.7 | 11.7 |
| Methyl Bromide | 10 | 15 |
| 3 Methyl 1 Butene | 1.5 | 9.1 |
| Methyl Cellosolve | 2.5 | 20 |
| Methyl Chloride | 7 | 17.4 |
| Methyl Ethyl Ketone | 1.9 | 10 |
| Methyl Mercaptan | 3.9 | 21.8 |
| Methyl Vinyl Ether | 2.6 | 39 |
| Monoethy lamine | 3.5 | 14 |
| Monomethy lamine | 4.9 | 20.7 |
| Nickel Carbonyl | 2 | |
| Pentane | 1.4 | 7.8 |
| Picoline | 1.4 | |
| Propane | 2.1 | 9.5 |
| Propylene | 2.4 | 11 |
| Propylene Oxide | 2.8 | 37 |
| Styrene | 1.1 | |
| Tetrafluoro ethylene | 4 | 43 |
| Tetrahydrofuran | 2 | |
| Toluene | 1.2 | 7.1 |
| Trichloro ethylene | 12 | 40 |
| Trimethylamine | 2 | 12 |
| Turpentine | 0.7 | |
| Vinyl Acetate | 2.6 | |
| Vinyl Bromide | 9 | 14 |
| Vinyl Chloride | 4 | 22 |
| Vinyl Fluoride | 2.6 | 21.7 |
| Xylene | 1.1 | 6.6 |

1: A system for safe laser power transmission to at least one remote receiver, the system comprising;
a transmitter unit, comprising:
at least one laser emitter generating a laser beam;
a beam aiming element adapted to direct the beam towards the at least one receiver; and
a laser power meter, positioned so that it determines the power of the laser beam;
wherein at least one of the receivers comprises:
a beam sensor, adapted to receive the laser beam;
a power meter configured to measure the level of power input to the receiver by the impinging laser beam; and
a communication link, configured to send back to the transmitter, a signal corresponding to the level of power input to the receiver by the impinging laser beam,
wherein the system further comprises a control unit adapted to determine whether the difference between the power of the laser beam transmitted and the power input to the receiver exceeds a predetermined level, and
wherein the wavelength of the at least one laser emitter is selected such that the laser beam has an absorption by an inflammable gas sufficiently high that the system can detect a predetermined minimal concentration of the gas in the air through which the beam travels, such that the system enables detection of the inflammable gas along the entire path of the laser beam in the region where a remote receiver may be found.

2: A system according to claim 1, wherein the laser beam further has an absorption by water vapor here that does not exceed a predetermined fraction of the absorption by the inflammable gas.

3: A system according to claim either of claims 1 and 2, wherein the control system is adapted to utilize the signal corresponding to the level of power input to the receiver to adjust the beam aiming element to ensure optimum impingement of the laser beam on the beam sensor.

4: A system according to any of the previous claims, wherein the control system is adapted to reduce the power emitted by the laser if the difference between the power of the laser beam transmitted and the power input to the receiver exceeds the predetermined level.

5: A system according to any of claims 1 to 3, wherein, if the difference between the power of the laser beam transmitted and the power input to the receiver exceeds the predetermined level, the control system is adapted to perform at least one of the following actions:
a. Turning the laser off, or reducing its power to a predetermined safe level;
b. Alerting the user;
c. Alerting automatic warning systems, such as an alarm system, or a smart hub;
d. Initiating a call to the fire department;
e. Sounding an alarm;
f. Turning on a visual warning signal; and
g. Disconnecting the gas supply, by use of a command to a controlled supply valve.

6: A system according to any of the previous claims, wherein the beam sensor is a photovoltaic cell.

7: A system according to any of the previous claims, further comprising DC/DC converter circuitry, adapted to convert the output current of the beam sensor to a current at a higher voltage, such that the current is at a voltage suitable for powering an externally connected electronic device.

8: A system according to any of claims 1 to 6, further comprising DC/DC converter circuitry, adapted to convert the output current of the beam sensor to a current at a higher voltage, such that the current is at a voltage suitable for charging the battery of an externally connected electronic device.

9: A system according to either of claims 7 and 8, further comprising a maximum power point tracking system, to ensure optimum efficiency of the DC/DC converter circuitry.

10: A system according to any of the previous claims, wherein the control unit is situated in the transmitter unit.

11: A system according to any of the previous claims, wherein the wavelength of the at least one laser emitter falls in at least one of the bands having wavelength ranges of 820-935 nm., 970-1125 nm., 1170-1350 nm., 1515-1545 nm. and 1620-1700 nm.

12: A system according to any of the previous claims, wherein the difference between the power of the laser beam transmitted and the power input to the receiver is a fractional difference.

13: A method of safe laser power transmission to at least one remote receiver, in a space where at least one inflammable gas powered appliance may be used, the method comprising:
measuring the power of a laser beam transmitted from a transmitter through the space towards a receiver,
measuring the power of the laser beam received by the receiver, after traversing the space; and
determining the difference between the power of the laser beam emitted from the transmitter into the space, and the power input to the receiver after traversing the space, and if the difference exceeds a predetermined level, turning the laser off, or reducing its power to a predetermined safe level,
wherein the wavelength of the laser beam is selected such that the beam has an absorption by an inflammable gas used in the appliance sufficiently high that a predetermined minimal concentration of the gas in the space through which the beam travels to the receiver, is sufficient to cause the predetermined level of power difference to be reached, such that the method enables detection of a dangerous level of the appliance gas along the entire path of the laser beam in the space where a remote receiver may be found.
